(19) United States
(12) Patent Application Publication
(10) Pub. No.: US 2021/0254789 A1
(43) Pub. Date: Aug. 19, 2021

(54) METHOD AND FACILITY FOR STORING AND DISTRIBUTING LIQUEFIED HYDROGEN

(71) Applicant: L'AIR LIQUIDE, SOCIÉTÉ ANONYME POUR L'ETUDE ET L'EXPLOITATION DES PROCÉDÉS GEORGES CLAUDE, Paris (FR)

(72) Inventors: François LAGOUTTE, Saint-Egreve (FR); Laurent ALLIDIERES, Saint Martin D'Uriage (FR); Fabien DURAND, Voreppes (FR); Pierre BARJHOUX, La Tronche (FR); Jean-Marc BERNHARDT, La Buisse (FR)

(73) Assignee: L'Air Liquide, Société Anonyme pour I'Etude et I'Exploitation des Precédés Georges Claude, Paris (FR)

(21) Appl. No.: 17/052,921

(22) PCT Filed: Apr. 29, 2019
(86) PCT No.: PCT/FR2019/050994

§ 371 Date: Nov. 4, 2020

(30) Foreign Application Priority Data
May 7, 2018 (FR) 1853927

(51) Int. Cl. F17C 5/04; F25J 1/00

(52) U.S. Cl. CPC F17C 5/04; F25J 1/001; F25J 2210/90; F17C 2265/061; F17C 2221/012; F17C 2223/033; F17C 2223/0161; F25J 2290/34

(57) ABSTRACT

A method for storing and distributing liquefied hydrogen using an installation having a storage facility for liquid hydrogen, a source of gaseous hydrogen, a liquefier having an inlet connected to the source and an outlet connected to the liquid hydrogen storage facility, the storage facility having a liquid withdrawal pipe having an end connected to the liquid hydrogen storage facility and an end configured to be connected to at least one mobile tank, the method having a stage of liquefying gaseous hydrogen and a stage of transferring the liquefied hydrogen to the storage facility, wherein the liquefied hydrogen has a temperature below the bubble point of hydrogen at the storage pressure and further having a stage of transfer of liquid hydrogen directly to the tank at a temperature between the saturation temperature at the pressure of the liquid and a temperature above the solidification temperature of the hydrogen.

### CROSS REFERENCE TO RELATED APPLICATIONS

This application is a 371 of International Application No. PCT/CN2018/084630, filed Apr. 26, 2018, which claims priority to French Patent Application No. 1853927, filed Apr. 29, 2018, the entire contents of which are incorporated herein by reference.

### BACKGROUND

The invention relates to a method and installation for storing and distributing liquefied hydrogen.

The invention relates more particularly to a method for storing and distributing liquefied hydrogen using an installation comprising a storage facility for liquid hydrogen at a predetermined storage pressure, a source of gaseous hydrogen, a liquefier comprising an inlet connected to the source and an outlet connected to the liquid hydrogen storage facility, the storage facility comprising a liquid withdrawal pipe comprising an end connected to the liquid hydrogen storage facility and an end intended to be connected to at least one mobile tank, the method comprising a stage of liquefaction of gaseous hydrogen supplied by the source and a stage of transfer of the liquefied hydrogen to the storage facility.

Due to its density in particular, liquid hydrogen is favored in comparison with gaseous hydrogen when large amounts of product have to be transported over long distances.

Another advantage of liquid hydrogen is related to its density and the large storage capacity in a hydrogen service station for fuel cell vehicles. A temperature of 20 K de facto eliminates all the impurities (which at this temperature are solid) from the gas, which optimizes the operation of the fuel cells.

On the other hand, due to the low density of liquid hydrogen (70 g/liter) in comparison with water, the pressure available by hydrostatic head and the low temperature can generate fairly large evaporation losses during liquid transfers.

Specifically, the systems for loading trucks and filling tanks in hydrogen liquefaction plants can result in losses which can range to up to 15% of production (for example 0.2% loss from the tank, 5% loss by flash vaporization in the valve for filling the tank and 10% loss in the methods for filling the trucks).

These evaporation losses can, of course, be recovered, reheated, recompressed after storage and reinjected into the liquefier. This is shown diagrammatically in FIG. 1, which represents an installation comprising a storage facility 4 for liquid produced. The hydrogen is produced from a source 2 of gaseous hydrogen which is liquefied in a liquefier 3 before its transfer to the storage facility 4. The boil-off gas can be withdrawn from a unit comprising, for example, in series, a heater 5, a buffer tank 6 (for example isobaric) and a compression component 7. The gas recovered and compressed can be admitted at the inlet of the liquefier 3 so that it can be reliquefied and reintroduced into the storage facility 4.

The storage facility 4 can provide for the supplying of tanks 8, in particular of liquid delivery trucks, for example by gravity or by pressure difference.

All or part of the hydrogen evaporated during these operations for filling tanks 8 of trucks can be vented or optionally recovered via a line 9 which reinjects this gas into the recovery and reliquefaction circuit.

These solutions generate losses of product (discharge to the air) or require proportioning the liquefier 3 and the gas recovery unit in order to be able to absorb the boil-off gases produced during the filling of trucks.

### SUMMARY

One aim of the present invention is to overcome all or some of the disadvantages of the prior art noted above.

To this end, the method according to the invention, moreover in accordance with the generic definition given for it in the preamble above, is essentially characterized in that the hydrogen liquefied by the liquefier and transferred to the storage facility at a temperature below the bubble point of hydrogen at the storage pressure.

Furthermore, embodiments of the invention can comprise one or more of the following characteristics:
the method comprises a stage of recovery of hydrogen originating from a mobile tank, the recovered hydrogen having a temperature greater than the bubble of hydrogen at the storage pressure, in particular vaporized gaseous hydrogen, the recovery stage comprising a transfer of said recovered hydrogen to the storage facility,
during the recovery stage, the recovered hydrogen is transferred to the liquid part of the storage facility,
the storage pressure is between 1.05 bar and 5 bar, in particular 2.5 bar,
the liquid hydrogen produced by the liquefier and transferred to the storage facility at a temperature between the saturation temperature at the pressure of the liquid and the saturation temperature at the pressure of 1.1 bar abs, in particular a temperature of 20.4 to 23.7 K for a storage pressure of 2.5 bar,
the liquid hydrogen produced by the liquefier and transferred to the storage facility at a temperature between the saturation temperature at the pressure of the liquid and the temperature just greater than the solidification temperature of the hydrogen, in particular a temperature of 15 K to 23.7 K for a storage pressure of 2.5 bar,
the liquid hydrogen produced by the liquefier is transferred directly to the tank and optionally also to the storage facility and has a temperature between the saturation temperature at the pressure of the liquid and the temperature just above the solidification temperature of the hydrogen, in particular a temperature of 15 K to 23.7 K for a storage pressure of 2.5 bar,
the stage of transferring the liquefied hydrogen to the storage facility (4) is carried out as soon as the level of liquid in the storage facility is below a predetermined threshold,
during the recovery stage, the recovered hydrogen is transferred directly to the storage facility (4), that is to say without precooling, the recovered hydrogen being cooled and, if appropriate, liquefied by the liquid hydrogen in the storage facility,

The invention also relates to an installation for storing and distributing liquefied hydrogen comprising a storage facility for liquid hydrogen at a predetermined storage pressure, at least one mobile tank, a source of gaseous hydrogen, a liquefier comprising an inlet connected to the source and an outlet connected to the liquid hydrogen storage facility, the storage facility comprising a liquid withdrawal pipe comprising an end connected to the liquid hydrogen storage facility and an end intended to be connected to the mobile tank(s), the liquefier being configured in order to produce and supply the storage facility with hydrogen at a temperature below the bubble point of hydrogen at the storage pressure and in that the installation comprises a vaporized gas recovery pipe comprising an end intended to be connected to the tank(s) and an end intended to be connected to the storage facility, in order to transfer this vaporized gas to the storage facility for the purpose of its liquefaction.

According to other possible distinguishing features:
the liquefier is configured in order to produce and supply the storage facility with hydrogen at a temperature lower by 0.1 to 12 K with respect to the bubble point of hydrogen at the storage pressure,
the liquefier is configured in order to produce and supply the storage facility with hydrogen at a temperature of between 20.4 K and 33 K for a storage pressure of between 1.05 and 12 bar and/or to produce and supply the storage facility with hydrogen at a temperature of between 15 K and 27.1 K for a storage pressure of between 1.05 and 5 bar,
the vaporized gas recovery pipe comprises a valve which makes it possible to isolate the tank from the storage facility,
the liquefier is configured in order to produce and supply the tank with hydrogen at a temperature of between 15 K and 27.1 K while retaining the pressure and the mass of hydrogen in the tank via direct reliquefaction,
the storage facility comprises a hydrogen gas phase and a hydrogen liquid phase,
the hydrogen gas and liquid phases of the storage facility have different respective temperatures, that is to say that the gas and liquid phases are not maintained at thermodynamic equilibrium in the storage facility,
the outlet of the liquefier is connected to the liquid hydrogen storage facility via a pipe emerging in the liquid phase of the storage facility,
the installation comprises a pipe having an end connected to the outlet of the liquefier and an end intended to be connected directly to the tank(s),
the storage facility is configured in order to concentrate the thermal inputs in its part harboring the gas phase, in particular in the upper part of the storage facility,
the storage facility (4) is suspended or supported by structural maintenance elements (15) predominantly connected to the upper part of the storage facility,
the storage facility is a vacuum-insulated jacketed tank,
the installation comprises a pipe having an end connected to the outlet of the liquefier and an end emerging in the gas phase of the storage facility,
the installation is configured in order to maintain the level of liquid in the storage facility above a predetermined threshold by automatically supplying the storage facility with hydrogen produced by the liquefier.

The invention may also relate to any alternative device or method comprising any combination of the features above or below within the scope of the claims.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 represents a diagrammatic and partial view illustrating the structure and the operation of an installation according to the prior art,

FIG. 2 represents a diagrammatic and partial view illustrating the structure and the operation of an example of installation according to the invention,

FIG. 3 represents a diagrammatic and partial view illustrating the structure and the operation of an example of installation according to the invention,

FIG. 4 represents a diagrammatic view illustrating an example of storage facility structure.

FIG. 5 represents a diagrammatic view illustrating an example of storage facility structure.

### DETAILED DESCRIPTION OF PREFERRED EMBODIMENTS

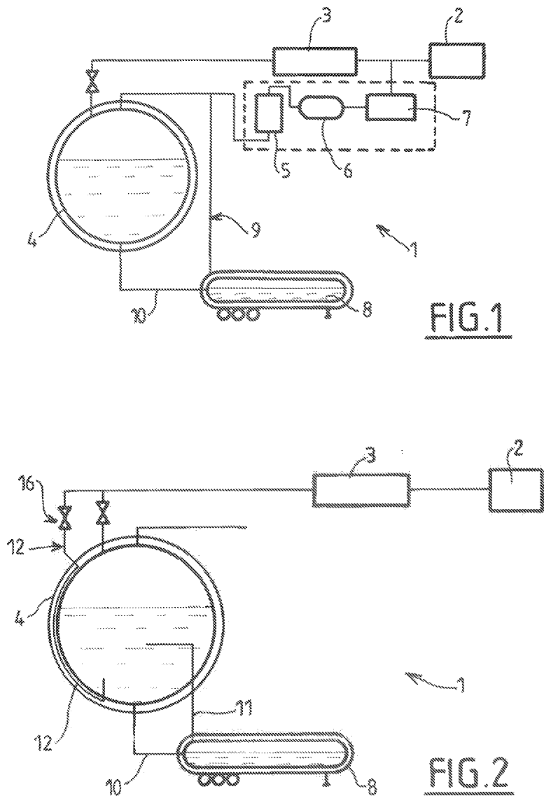

An installation 1 for storing and distributing liquefied hydrogen according to an implementational example of the invention is represented in FIG. 2. The same elements as those of FIG. 1 are designated by the same numerical references.

The installation 1 comprises a storage facility 4 for liquid hydrogen at a predetermined storage pressure 4. This storage facility is, for example, a vacuum-insulated storage facility of high capacity, for example of several thousand liters. This storage facility 4 conventionally contains a liquid phase with a vapor phase.

Conventionally, the storage pressure is preferably regulated, for example at a fixed value (for example between 1.05 and 11 bar, for example between 1.1 and 5 bar, in particular 2.5 bar absolute).

“Storage pressure” is understood to mean, for example, the mean pressure in the storage facility or in the bottom part of the storage facility or in the upper part (in the gas headspace). This is because, as a result of the low density of hydrogen, the pressure in the lower part of the storage facility is substantially equal to the pressure in the upper part.

The installation additionally comprises a source 2 of gaseous hydrogen and a liquefier 3 comprising an inlet connected to the source 2 and an outlet connected to the liquid hydrogen storage facility 4.

The source 2 can be a hydrogen network and/or a unit for the production of hydrogen (for example steam reforming and/or by electrolysis or any other appropriate source).

The hydrogen supplied by the source 2 and liquefied by the liquefier 3 can be transferred to the storage facility 4 intermittently and/or continuously and/or in the event of the liquid level in the tank falling below a predetermined threshold. Preferably, the liquid level in the storage facility 4 is automatically controlled via the supplying on the part of the liquefier 3 (flow rate from the liquefier 3 and/or valve regulating the flow rate of liquid supplied to the storage facility 4).

The installation additionally comprises a pipe 10 for withdrawing liquid comprising an end connected to the liquid hydrogen storage facility 4 and an end intended to be connected to one or more tank(s) 8 to be filled, in particular mobile tank(s), such as tanks mounted on delivery trucks.

These trucks can in particular supply fixed tanks, in particular stations for supplying hydrogen to vehicles.

According to one distinguishing feature, the liquefier 3 is configured in order to produce and to supply the storage facility 4 with hydrogen at a temperature below the bubble point of hydrogen at the storage pressure.

The storage pressure is, for example, between 1.05 bar and 5 bar, in particular 2.5 bar.

For example, the liquid hydrogen produced by the liquefier 3 and transferred to the storage facility 4 has a temperature lower by 0.1 to 12 K with respect to the bubble point of hydrogen at the storage pressure, in particular at a temperature of between 16 K and 23 K for a storage pressure of between 1.05 and 11 bar, in particular a temperature of 20.4 to 21 K for a storage pressure of 2.5 bar.

That is to say that the liquefier 3 produces a liquid which is subcooled with respect to the configurations of the prior art, that is to say to a temperature below the bubble point of hydrogen at the pressure of the storage facility 4.

Bubble point designates the temperature (at a given pressure) from which the first bubbles from boiling (vaporization) appear.

Preferably, the liquefier 3 directly supplies the liquid hydrogen at subcooled thermodynamic conditions. For example, at the outlet of the liquefier 3, the hydrogen has subcooling conditions which optionally take into account the heating in the circuit leading as far as the storage facility.

Preferably, the hydrogen liquid and gas phases are not at thermodynamic equilibrium in the storage facility 4. That is to say that the hydrogen gas and liquid phases of the storage facility 4 have different respective temperatures. In particular, the hydrogen can be maintained at a stable pressure (storage pressure) but the temperature of the hydrogen, in particular gaseous hydrogen, can be stratified between the cold liquid phase in the lower part and the warmer gas part in the upper part.

In this configuration (different temperatures between the gas part and the liquid part), the great majority of the gas part can be at a temperature of 40 K.

In point of fact, the critical point of hydrogen is 12.8 bar at 33 K. It is thus not possible to condense the gas by increasing the gas pressure isothermally at 40 K.

It can then be easily concluded that, in a first approach, pressurization of the storage facility 4 by adding cold liquid via the bottom of the storage facility 4 is possible without condensation of the gas headspace.

It is thus possible to obtain a metastable (or unstable) thermodynamic system comprising a relatively “warm” gas headspace (at a temperature greater than or equal to 40 K, for example) and a liquid part having a temperature corresponding to its bubble point, or below. This is a particular case of a subcooled liquid associated with a temperature-stratified gas headspace.

The storage facility 4 can preferably be spherical.

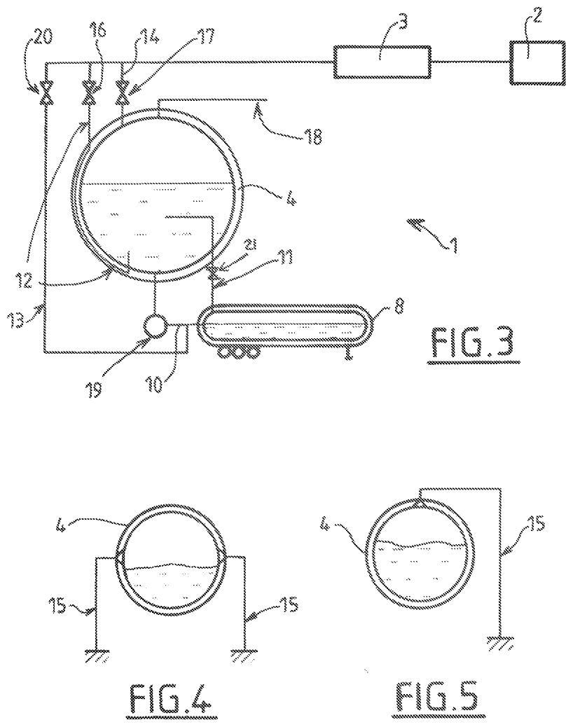

In addition, preferably, this storage facility 4 is configured so that the majority of the heat inputs take place by its upper part. As represented diagrammatically in FIGS. 4 and 5, the storage facility 4 can be suspended or supported by structural maintenance elements 15 (tie rods, arms, and the like) predominantly connected to the upper part of the storage facility 4. Thus, the thermal inputs which predominantly pass through these structural elements will thus predominantly heat the upper part of the storage facility 4. The tie rods or supporting elements can be positioned in the vacuum interwall space and can be connected to the upper part of the internal shell which contains the fluid.

This configuration makes possible greater (temperature-)stratification of the gas phase.

Thus, the storage facility 4 can be filled via a filling pipe 12 which emerges in the liquid part, in particular in the bottom of the storage facility 4. For example, this pipe 12 can pass through the vacuum insulation space between the storage facility 4 interwall (cf. FIG. 2).

The transfer/filling can be controlled via a valve 16 (for example a piloted valve).

The pressure in the storage facility 4 can be controlled, for example, by controlling the pressure of the gas headspace. For example, the pressure can be increased (conventional device for injecting warmer hydrogen into the gas headspace, not represented in the figure for the sake of simplification). That is to say that a device for increasing pressure can withdraw liquid from the storage facility, reheat it and reinject it into the upper part of the storage facility 4.

In order to decrease the pressure in the storage facility 4, one solution can consist in injecting liquid hydrogen originating from the liquefier 3 by spraying into the gas part. This can be carried out via a suitable pipe 14 provided with a valve 17, for example. In order to reduce the pressure in the storage facility 4, it is also possible to discharge to the air a part of the gaseous hydrogen contained in the gas headspace (for example, pipe 18 provided with a valve, not represented).

Thus, this liquid in the storage facility 4 has an “energy reserve” or “frigories reserve” before starting to evaporate.

The liquefier 3 can, for example, be a liquefier, the working fluid of which comprises or consists of helium. For example, the liquefier 3 can comprise a “Turbo-Brayton”cryogenic system sold by the applicant, which can provide in particular a refrigeration and a liquefaction from 15 K to 200 K.

Of course, any other liquefaction solution can be envisaged. Thus, for example, other configurations are possible with hydrogen working fluid cycles comprising vacuum expansion valves, or with systems for postliquefaction subcooling of hydrogen of the liquid turbine or additional helium cycle type.

This configuration makes it possible to recover and to condense the warmer hydrogen originating from a filled tank 8, without requiring a system described in connection with FIG. 1.

This configuration also makes it possible to condense the warmer hydrogen in a tank 8 while retaining the mass of hydrogen initially present in this tank 8.

To this end, the installation can comprise a pipe 11 (preferably fitted with a valve 21, cf. FIG. 3) for recovering vaporized gas comprising an end intended to be connected to the tank(s) 8 and an end intended to be connected to the storage facility 4, in order to transfer this vaporized gas to the storage facility 4 with a view to its liquefaction.

The tanks 8 can then be filled in four different ways.

According to a first possibility, filling is carried out by the thermosiphon effect. The hot point (the tank 8) is lower than the cold point (the storage facility 4); a natural convection of liquid hydrogen will then be set up naturally and will fill the tank 8, which is hydraulically connected to the storage facility 8 via the withdrawal pipe 10.

In this configuration, the warm two-phase mixture which returns to the storage facility 8 via the recovery pipe 11 is recondensed in the liquid part of the storage facility 8 (subcooled hydrogen). A small intermediate storage facility at a lower pressure can optionally be used for the priming of the system.

According to a second possible configuration, the filling of tanks 8 can be forced via a pump 19 or any other equivalent member. The pump 19 is, for example, located in the withdrawal pipe 10. In this case, the liquid hydrogen is injected into the tank 8 and the evaporated liquid returns to the storage facility 4 via the recovery pipe 11. As above, the warm fluid recovered is condensed on contact with the subcooled hydrogen contained in the storage facility 4.

This warm fluid can be cooled in the liquid phase via a condenser (optional) or directly by bubbling into the liquid.

This forced-circulation configuration makes it possible to reduce the filling time of the tank 8.

According to a third possibility, the installation can comprise a pipe 13 having an end connected to the outlet of the liquefier 3 and an end intended to be directly connected to the tank(s) 8 (without passing through the storage facility 4), cf. FIG. 3. The pipe 13 can be equipped with a valve 20 (preferably a piloted valve) in order to transfer liquid hydrogen from the liquefier 3 to the tank 8. As above, the warm fluid recovered by the recovery pipe 11 is returned to the storage facility 4 in order to be cooled/condensed there. This configuration advantageously makes it possible to fill tanks 8 with subcooled hydrogen at a pressure greater than the maximum operating pressure of the tank 4, without using a pump.

According to a fourth possibility, the installation can comprise a pipe 13 having an end connected to the outlet of the liquefier 3 and an end intended to be directly connected to the tank(s) 8 to be filled (without passing through the storage facility 4), cf. FIG. 3. The pipe 13 can be equipped with a valve 20 (preferably a piloted valve) in order to transfer liquid hydrogen from the liquefier 3 to the tank 8. The warm fluid present in the tank 8 is kept in the tank 8 by closing the valve 21 on the pipe 11 for return to the storage facility 4, until the pressure in the tank 8 has fallen sufficiently (down to a predetermined pressure level) as a result of the condensation of the warm vapors by the subcooled liquid hydrogen originating from the liquefier 3. As above, the warm fluid can subsequently be recovered by the recovery pipe 11 and then returned to the storage facility 4 in order to be cooled/condensed there.

The valve 21 of the return pipe 11 thus makes it possible to retain the pressure and the mass of hydrogen in the storage facility 8 by direct reliquefaction.

The various possibilities can be used on the same installation when the pressure and filling conditions for the storage facilities 4 and 8 will be optimized for each solution and will thus increase the liquid yield of the complete installation.

The losses by evaporation linked to the filling of tanks 8 are then at least partly compensated for by the subcooling of the hydrogen contained in the storage facility 4 (first or second solution) or by the subcooled hydrogen which originates directly from the liquefier 3.

According to these solutions, it is thus not necessary to invest in a system for recirculation of the evaporated gases and the mobile tanks 8 can advantageously return to the installation 1 without prior depressurization or prior cooling.

This solution requires a relatively low investment and only slightly increases the liquefaction energy consumption of the installation.

Depending on the price of energy or on the value of hydrogen, the system described can even make possible an overall saving with regard to the liquefaction cost.

The invention can make it possible, if appropriate, to increase the subcooling of the liquid when the hydrogen demand is lower than the nominal capacity. This is because the capacity for production of subcooled hydrogen decreases with the level of subcooling. This can make it possible to advantageously adjust the level of subcooling of the liquid contained in the storage facility 4.

Thus, while being of simple and inexpensive structure, the invention makes it possible to reduce the losses of gas by evaporation during transfers of cryogenic liquid to delivery trucks or other mobile tanks 8.

The solution can, if appropriate, make the most of the advantages of subcooled hydrogen over existing liquefiers by addition of a system for cooling the liquid and cooling the tanks 8 to be filled. The net liquefaction capacity of the existing unit can also be increased as a result of the reduction in the hydrogen vapors to be recovered.

The invention can be applied to gases other than hydrogen, if appropriate.

By way of example, the sections below compare operating data between the prior art corresponding to FIG. 1 and the invention.

In the configuration of FIG. 1, the gaseous hydrogen originating from the source can be at ambient temperature and have a pressure of 1.1 to 30 bar abs and a flow rate between 1 and 100 t/day. The liquid hydrogen supplied by the liquefier 3 can have a pressure of between 1.05 and 12.8 bar and a temperature of between 20.4 and 33 K. The liquid hydrogen transferred to the tank 8 can have a pressure of between 1.05 and 12 bar and a temperature between 20.4 and 33 K. The flash (vaporized) gas from the warm tank 8 to be filled can have a pressure of between 1.3 and 5 bar abs and a temperature of 30 to 150 K. This flash gas can be reheated to ambient temperature and then recompressed to a pressure of 30 bar, for example.

On the other hand, in the configuration of the invention (FIG. 2 or 3), the gaseous hydrogen originating from the source 2 can be at ambient temperature and have a pressure of 1.1 to 30 bar abs and a flow rate of 1 to 100 t/day but less than the flow rate of the first configuration. The liquid hydrogen supplied by the liquefier 3 can have a pressure of between 1.1 and 12 bar and a temperature of between the saturation temperature and 16 K. The liquid hydrogen transferred to the tank 8 can have a pressure of between 1.1 and 12 bar (depending on whether the transfer is carried out by thermosiphon or via a pump) and a temperature of 20.4 K. The flash (vaporized) gas from the warm tank 8 to be filled can have a pressure of between 1.2 and 12 bar abs and a temperature of 30 to 150 K. The liquefied gas can be returned to the tank 8 at pressure conditions of between 2.5 and 5 bar abs and a temperature of 30 to 50 K. These figures are given by way of example for a storage facility having an endurance of 5 days of production and losses by evaporation of 0.2% of its volume per day.

The subcooled liquid can be transferred to the tank 8 into the gas phase of the latter. For example, one or more nozzles can be provided for this purpose. This or these nozzles are preferably oriented toward the top of the tank (theoretically the warmest zone). This makes it possible to improve the efficiency of the depressurization of the tanks 8.

The liquefier 3 is preferably configured in order to supply the liquid (for example hydrogen) under pressure. It is thus possible to provide a natural hydraulic path which avoids installing a specific cryogenic device to counter the head losses over the circuit between the liquefier and the downstream end. This thus makes it possible to dispense with a compressor or with a cryogenic pump which would complicate the installation (low power, thus not insignificant thermal inputs, necessary maintenance, potential icing, and the like).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. A method for storing and distributing liquefied hydrogen using an installation comprising a storage facility for liquid hydrogen at a predetermined storage pressure, a source of gaseous hydrogen, a liquefier comprising an inlet connected to the source and an outlet connected to the liquid hydrogen storage facility, the storage facility comprising a liquid withdrawal pipe comprising an end connected to the liquid hydrogen storage facility and an end configured to be connected to at least one mobile tank, the method comprising a stage of liquefying gaseous hydrogen supplied by the source and a stage of transferring the liquefied hydrogen to the storage facility, wherein the hydrogen liquefied by the liquefier and transferred to the storage facility has a temperature below the bubble point of hydrogen at the storage pressure and further comprising a stage of transfer of liquid hydrogen produced by the liquefier directly to the tank at a temperature between the saturation temperature at the pressure of the liquid and a temperature above the solidification temperature of the hydrogen, wherein the temperature is between 15 K and 23.7 K, which results in a storage pressure of 2.5 bar.

2. The method as claimed in claim 1, further comprising a stage of recovery of hydrogen originating from a mobile tank, the recovered hydrogen having a temperature greater than the bubble of hydrogen at the storage pressure, the recovery stage comprising a transfer of said recovered hydrogen to the storage facility.

3. The method as claimed in claim 2, wherein, during the recovery stage, the recovered hydrogen is transferred to the liquid part of the storage facility.

4. The method as claimed in claim 2, wherein the storage pressure is between 1.05 bar and 5 bar.

5. The method as claimed in claim 1, wherein the liquid hydrogen produced by the liquefier and transferred to the storage facility has a temperature between the saturation temperature at the pressure of the liquid and the saturation temperature at the pressure of 1.1 bar abs.

6. The method as claimed in claim 1, wherein the liquid hydrogen produced by the liquefier and transferred to the storage facility has a temperature between the saturation temperature at the pressure of the liquid and the temperature just above the solidification temperature of the hydrogen.

7. The method as claimed in claim 1, wherein the stage of transferring the liquefied hydrogen to the storage facility is carried out as soon as the level of liquid in the storage facility is below a predetermined threshold.

8. An installation for storing and distributing liquefied hydrogen comprising a storage facility for liquid hydrogen at a predetermined storage pressure, at least one mobile tank, a source of gaseous hydrogen, a liquefier comprising an inlet connected to the source and an outlet connected to the liquid hydrogen storage facility, the storage facility an upper part containing hydrogen in gas form and a lower part a liquid phase the storage facility comprising a liquid withdrawal pipe comprising an end connected to the liquid hydrogen storage facility and an end configured to be connected to the mobile tank(s) wherein the liquefier is configured in order to produce and supply the storage facility with hydrogen at a temperature below the bubble point of hydrogen at the storage pressure and in that the installation comprises a vaporized gas recovery pipe comprising an end configured to be connected to the tank(s) and an end configured to be connected to the storage facility, in order to transfer this vaporized gas to the storage facility for the purpose of its liquefaction, a pipe having an end connected to the outlet of the liquefier and an end configured to be connected directly to the tank(s).

9. The installation as claimed in claim 8, wherein the liquefier is configured in order to produce and supply the storage facility with hydrogen at a temperature lower by 0.1 to 12 K with respect to the bubble point of hydrogen at the storage pressure.

10. The installation as claimed in claim 8, wherein the liquefier is configured in order to produce and supply the storage facility with hydrogen at a temperature of between 20.4 K and 33 K for a storage pressure of between 1.05 and 12 bar and/or to produce and supply the storage facility with hydrogen at a temperature of between 15 K and 27.1 K for a storage pressure of between 1.05 and 5 bar.

11. The installation as claimed in claim 9, wherein the vaporized gas recovery pipe comprises a valve which makes it possible to isolate the tank from the storage facility.

12. The installation as claimed in claim 11, wherein the liquefier is configured in order to produce and supply the tank with hydrogen at a temperature of between 15 K and 27.1 K while retaining the pressure and the mass of hydrogen in the tank via direct reliquefaction.

13. The installation as claimed in claim 8, wherein the storage facility comprises a hydrogen gas phase and a hydrogen liquid phase.

14. The installation as claimed in claim 13, wherein the hydrogen gas and liquid phases of the storage facility have different respective temperatures.

15. The installation as claimed in claim 8, wherein the outlet of the liquefier is connected to the liquid hydrogen storage facility via a pipe emerging in the liquid phase of the storage facility.

16. The installation as claimed in claim 8, wherein the storage facility is configured in order to concentrate the thermal inputs in its part containing the gas phase.

17. The installation as claimed in claim 8, wherein the storage facility is suspended or supported by structural maintenance elements predominantly connected to the upper part of the storage facility.
